(19) United States
(12) Patent Application Publication
(10) Pub. No.: US 2008/0166923 A1
(43) Pub. Date: Jul. 10, 2008

(54) Telecommunications Module, Assemblies Thereof And Methods Of Using Same

(75) Inventor: Friedrich W. Denter, Castrop-Rauxel (DE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/816,334

(22) PCT Filed: Feb. 23, 2006
(86) PCT No.: PCT/US2006/006516

§ 371 Date: Aug. 15, 2007

(30) Foreign Application Priority Data
Mar. 4, 2005 (EP) 05004795.0

(51) Int. Cl. H01R 13/35

(52) U.S. Cl. 439/668

(57) ABSTRACT

A telecommunications module (10) has a housing (12) and at least one contact comprising at least one first contact element (14) located adjacent a receiving space (24) for receiving at least one outside contact (30), the contact element (14) having, in a portion bordering the receiving space (24), both a flexible zone (26) and a zone (28), which is less flexible than the flexible zone (26) and/or supported so as to exhibit a restrained deformability by force acting thereon from the side of the receiving space (24). Furthermore, an assembly of a telecommunications module and at least one outside module and a method of using a telecommunications module are disclosed.

### TECHNICAL FIELD

The invention relates to a telecommunications module, an assembly of a telecommunications module and at least one outside module and a method of using a telecommunications module.

### BACKGROUND

In the field of telecommunications, numerous customers are connected with the switch of a telecommunications company via telecommunications lines. The customers can also be called subscribers. The switch is also called an exchange or PBX (central office exchange operated by the telecommunications company). Between the subscriber and the switch, sections of the telecommunications lines are connected with telecommunications modules. The telecommunications modules establish an electrical connection between a wire, which is attached to the telecommunications module at a first side, and another wire, which is attached to the telecommunications module at a second side. The wires of one side can also be called incoming wires and the wires of the other side can be called outgoing wires. Plural telecommunications modules can be put together at a distribution point, such as a main distribution frame, an intermediate distribution frame, an outside cabinet or a distribution point located, for example, in an office building or on a particular floor of an office building. To allow flexible wiring, some telecommunications lines are connected with first telecommunications modules in a manner to constitute a permanent connection. Flexibility is realized by so-called jumpers or cross connects, which flexibly connect contacts of the first telecommunications module with contacts of a second telecommunications module. These jumpers can be changed when a person moves within an office building to provide a different telephone (i.e. a different telephone line) with a certain telephone number, which the relocated person intends to keep. In the telecommunications module, disconnection points can be located in the electrical connection between the two sides. At such disconnection points, disconnection plugs can be inserted, in order to disconnect the line. Furthermore, protection plugs and magazines are known. These are connected to the module and protect any equipment connected to the wires from overcurrent and overvoltage. Finally, test plugs can be inserted at a disconnection point in order to test or monitor a line.

Recently, ADSL-technology has spread widely in the field of telecommunications. This technology allows at least two different signals to be transmitted on a single line. This is achieved by transmitting the different signals at different frequencies along the same line. The signals are combined at a particular point in the telecommunications line and split at another point. In particular, at the subscriber side, voice and data signals, which are separate, are combined and sent to the central office via the same line. In the central office the combined signal is split. For the transmission of voice and data signals to the subscriber, separate voice and data signals are combined at the central office, sent to the subscriber and split at the subscriber side. After splitting the signal, the so-called POTS-signal (plain old telephone service) can be used to transmit voice signals. The remaining part of the split signal can be used to transmit data, for example. So-called splitters, which are used to split or combine the signal, can generally be arranged at any distribution point.

Any electronic components, which are necessary to perform the above functions, can be contained, possibly together with a printed circuit board as a base, in a functional module, which can be called a splitter module. Similar functional modules are protection modules, which contain any components which provide protection against overvoltage and/or overcurrent, as well as testing and monitoring modules, which contain suitable electronic components and circuits in order to test and/or monitor a telecommunications line. Furthermore, other functional modules in the above sense are known to those skilled in the art.

An over-voltage protection cartridge is commercially available from Quante, 3M Telecommunications of Neuss, Germany under the designation OVP-magazine. This cartridge has a plurality of pairs of contacts, which are insertable into a receiving space of a telecommunications module. When the cartridge is fully inserted, a lever of the cartridge is turned so as to spread the contacts of the cartridge apart. This applies a biasing force to the contact elements of the telecommunications module so as to establish a reliable electrical connection.

EP 04 006 530.2 of the Applicant describes an assembly of three telecommunications modules, to which a splitter module can be fitted from a rear side of the telecommunications module. An electrical connection between the contact elements of the telecommunications modules and the outside contacts of the splitter module is established. Similar assemblies are known from the Applicant's EP 04 006 529.4 and EP 04 027 881.4.

### SUMMARY OF THE INVENTION

The invention provides a telecommunications module, which is improved with regard to the reliability of the electrical connection with different types of outside contacts of outside modules. Furthermore, an assembly of a telecommunications module and at least one outside module as well as a method of using a telecommunications module are provided.

The telecommunications module, firstly, comprises a housing. The housing can be made of plastic or any other suitable material and can be constituted by one or more components. The housing serves to accommodate the contacts of the telecommunications module, as detailed below. The housing can also have specific structures for positioning the contacts therein. Moreover, the housing can comprise one or more cavities or receiving spaces, which are adapted to accommodate objects such as the functional modules described above or any other types of outside modules or parts thereof. Finally, the housing can comprise suitable structures, typically at the outside thereof, to enable the telecommunications module to be mounted to a rack or any other suitable carrier in the field of telecommunications.

The telecommunications module, secondly, comprises at least one contact. A contact generally means any component, which is, firstly, adapted to establish electrical connection with at least one outside wire. For this purpose, the contact can, for example, at a first end thereof, be formed as an IDC (Insulation Displacement Contact), a wire wrap contact or in any other suitable manner. The contact can consist of a single contact element, on the first end of which a wire is connected, and on a second end of which an electrical connection with a further component is established. This can, for example, be the outside contact of an outside module, such as splitter module. In this case, the signal, which is transmitted from the wire to the contact element, is further transmitted to the electronic components of the splitter modules and is processed by these. The contact can also comprise a second contact element, on the first end of which a wire can be connected. The second end of the second contact element can, for example, be connected with a splitter module, so that the signal, which is processed, split or combined by the splitter module is, via the second contact element, transmitted to the wire connected with the first end of the second contact element. It is, however, to be emphasized that a particular contact of the telecommunications module described herein does not necessarily comprise two contact elements, but one contact element, called the first contact element, can be sufficient. Furthermore, the first and/or second contact element can at least be partially located outside the housing.

The at least one first contact element is located at least partially adjacent a receiving space. The receiving space serves to receive at least one outside contact. The receiving space can at least partially be located outside the housing of the telecommunications module and essentially means any space, which allows the outside contact of an outside module to be at least partially accommodated therein. Moreover, the receiving space can be adapted to accommodate further portions of the outside module.

The contact has, firstly, in a portion bordering the receiving space, a flexible zone. This flexible zone serves to establish electric contact with at least one outside contact. For this purpose, the portion having the flexible zone borders the receiving space, so that the outside contact, when it is inserted into the receiving space, can be in contact with the flexible zone. In particular, the flexible zone is advantageous for establishing contact with an outside contact, which is comparably rigid. Such a rigid contact can, for example, be present as a kind of contact pad on a printed circuit board. As will be apparent, such an outside contact will be substantially non-flexible. Therefore, it is advantageous to provide flexibility to the contact element of the telecommunications module in the described flexible zone. Thus, the sizes and positional relationships between the flexible zone and the outside contact can be chosen so as to provide a biasing force, with which the flexible zone is reliably held against the outside contact. In this context, the flexible zone can, firstly, be formed in a portion of the contact element, which contacts, i.e. touches the outside contact. However, the portion of the contact, which comes into contact with the outside contact, can as such be relatively rigid, and a flexible zone can be provided in another portion of the contact, so as to allow movement and/or deformation of the so-called flexible zone. This, as described above, leads to a reliable electrical connection, for example, with a relatively rigid outside contact.

The contact, secondly, comprises a zone, which is less flexible than the above described flexible zone and/or supported so as to exhibit a restrained or limited deformability by forces acting thereon from the side of the receiving space. This zone, which will be called less flexible zone hereinafter, is advantageous for achieving electric contact with flexible or movable outside contacts. In this case, the kind of biasing force, which serves to hold the outside contact and the contact of the telecommunications module in tight contact, is essentially applied by the outside contact. Thus, the outside contact can be flexible, or it can be moveable so as to move the outside contact towards the contact of the telecommunications module. Thus, in order to apply a counterforce to a force acting from the outside contact, the less flexible zone is provided. In this context, it is to be noted, that the less flexible zone as such can be moveable. For example, without any outside contact inserted, the less flexible zone can be in a first position. The less flexible zone can then, when the outside contact is inserted, be moved in a second position. This movement can either be provided by a certain flexibility of the described less flexible zone or by a movement of the less flexible zone, which is allowed by flexible portions of the contact, which can, for example, be provided adjacent the less flexible zone. In any case, at least in such a second position, the less flexible zone is not deformable anymore, and/or is supported so as to be substantially non-deformable. Thus, a biasing force, in order to establish a reliable contact, can be applied by the outside contact, and the required counterforce is applied by the less flexible zone.

With this flexible zone, the contact is, for example, suitable for cooperating with outside contacts, which are moveable, for example, can be spread apart in order to reliably contact the contacts of the telecommunications module. However, the telecommunications module is, therefore, not only adapted to be combined with outside modules having this type of flexible or moveable contacts. Rather, because of the above-described flexible zone, the telecommunications module can also be combined with outside modules having rigid contacts, such as contacts formed on a printed circuit board. In summary, the telecommunications module described herein is improved with regard to its versatility for being combined with outside modules having different types of outside contacts. For these different types of outside contacts, reliable electrical connection can be established. As described above, the flexible and the less flexible zone can be formed on one and the same contact element of the contact. However, in special cases, the contact can comprise more than one contact element, and the flexible zone can be formed on one particular contact element and the less flexible zone can be formed on another contact element.

Generally, the positional relationship between the flexible and the less flexible zone can be chosen in accordance with the specific needs. However, it is currently preferred that the flexible zone is located further inside the housing than the less flexible zone. “Further inside” refers to an insertion direction, in which an outside module is inserted into the receiving space. Thus, when the outside module is inserted, the leading portions thereof will, firstly, pass the less flexible zone and then the flexible zone. As a consequence, an outside module having rigid contacts will typically be inserted further into the telecommunications module than an outside module having flexible and/or moveable contacts.

Whereas the flexible and inflexible zone can be provided on different contact elements of and the same contact, it is advantageous, if a first contact element comprises both the flexible and the less flexible zone.

As already mentioned above, the contacts of the telecommunications module can each have second contact elements. The second contact element at least has a portion, which also borders the receiving space. Thus, at least a part of the receiving space will be present between the first and second contact elements. Thus, the outside contacts of an outside module can be accommodated in the receiving space and can be in contact with both the first and the second contact element. In such a situation, these contact elements can be tapped in order to establish an electrical connection with an overvoltage protection magazine. Thus, if overvoltage is applied, the overvoltage protection magazine can provide suitable protection. Furthermore, if the outside module is a splitter module, the signal transmitted by the first contact element can be processed by the splitter circuits of the splitter module, and can then be transmitted to one or more second contact elements.

When a second contact element is present, it has been found advantageous to provide the first and second contact elements so that they are, at least in the area of the receiving space, mirror images of each other. Thus, the characteristics of both contact elements are at least very similar, and almost identical contact performances are achieved by both contact elements.

As regards the structure of the less flexible zone, the less flexible zone can, for example, be supported by the housing. This support is, as described above, at least present in certain positions of the second contact element. Furthermore, the housing can readily be formed so as to support the less flexible zone in a manner to be substantially not deformable.

In particular, the less flexible zone can be formed substantially straight, so that this structure as such can, in comparison to a bend or bulge, provide the required rigidity. Furthermore, a straight portion constituting the less flexible zone can readily be supported by a straight and flat area of the telecommunications module. In this context, straight refers to a sectional view and essentially means a flat, for example, strip-like portion of a contact element.

In order to reliably cooperate with flexible contacts of an outside module, the less flexible zone can be supported so as to be substantially non-deformable.

As regards the flexible zone, this zone can, for example, be formed rounded so as to provide the required flexibility. Also in this context, reference can be made to a sectional view, in which the rounded or curved shape is visible.

In particular, the flexible zone can be formed in a bulge in order to provide flexibility for the flexible zone. In more general terms, the flexible zone can be of a convex shape. It can be noted that the less flexible zone can be of a concave shape and/or can have a structure which converges towards that direction from which an outside contact is insertable.

As mentioned above, the receiving space is assessable so that an outside module can, at least partially, be inserted therein. In particular, the outside contacts of the outside module can be insertable into the receiving space so as to come into contact with the contact elements of the telecommunications module. In this context, the opening, through which the receiving space is assessable, can at least partially widen in a direction towards the inside of the housing. Thus, support for the less flexible zone can be present in a narrower entrance area, and sufficient space to allow deformation and/or movement of the flexible zone can be present further inside the telecommunications module.

Generally, the receiving space can be at any suitable side of the telecommunications module. However, it is considered advantageous to provide access to the receiving space at a rear side of the telecommunications module, when wires are connected to the contact elements of the telecommunications module at a front side thereof. Thus, any outside modules, which are at least partially inserted into the receiving space, do not interfere with wires connected to the telecommunications module. Thus, the handling properties of the novel telecommunications module are improved.

As described above, two contact elements can constitute a contact. In particular, the contact elements of a particular contact can be touching each other in a first portion thereof, so that these are connected. Only when an outside contact is inserted between them, they are disconnected, and connection with the outside contacts is established. Thus, when an outside module is inserted, the point, where the first and second contact elements are connectable with and disconnectable from each other, cannot be used anymore. However, in certain situations, it is desirable to provide such a disconnection point, for example, in order to allow the insertion of additional modules or plugs, such as test plugs. This can be realized by providing a third contact element, which is connectable with and disconnectable from the first or second contact element at a disconnection point.

As described above, the invention also provides an assembly of a telecommunications module in one of the above-described embodiments and at least one outside module having at least one of the outside contacts. Thus, in such a combination with at least one outside module, the advantages of the novel telecommunications module including the improved contacts thereof can be used for the connection with at least one outside module. Moreover, additional functions, such as overvoltage and/or overcurrent protection and/or splitting or combining of a signal can be provided. In particular, different types of outside modules can be combined with one and the same telecommunications module at a certain point in time in order to provide different services and/or protection to different telecommunications lines.

In the above-described assembly the one or more contacts of the outside module can be flexible and can, thus, be advantageously employed to establish connection with the less flexible zone.

In a similar manner, the combination of flexible and less flexible contacts/zones can be the other way around, so that the outside contact can be substantially inflexible and adapted to be in contact with the flexible zone. Also in this combination, a reliable electrical connection can be established.

For example, the outside module can comprise relatively rigid contacts, which can be formed on at least one printed circuit board.

As examples for outside modules, with which the telecommunications module described herein can be advantageously combined, an overvoltage protection and/or a splitter module can be mentioned.

The invention, finally, provides a method of using the telecommunications module in one of the above-described embodiments, wherein at least one outside module having at least one flexible contact is at least partially inserted into the telecommunications module and removed from the telecommunications module at a later point in time, and wherein at least one outside module having at least one substantially inflexible contact is then at least partially inserted into a telecommunications module. The invention also provides a method, in which the different outside modules are used in the other order, i.e. an outside module having at least one substantially inflexible contact is inserted first, then removed, and at least one outside module having at least one flexible contact is inserted thereafter. Thus, the described method reflects the enhanced versatility of the novel telecommunications module and advantageously allows different outside modules to be employed at different times.

The outside module having the at least one flexible contact can, for example, be an overvoltage protection module and the outside module having the substantially inflexible contact can, for example, be a splitter module.

### BRIEF DESCRIPTION OF THE DRAWINGS

Hereinafter, the invention will be described by non-limiting examples thereof with reference to the drawings, in which:

FIG. 1 shows a schematic sectional view of a first embodiment of the telecommunications module in combination with a first type of outside module.

FIG. 2 shows a schematic sectional view of a part, denoted Y, of the embodiment of FIG. 1 in combination with a second type of outside module.

FIG. 3 shows a sectional side view of a part of the telecommunications module in a second embodiment.

### DESCRIPTION OF PREFERRED EMBODIMENTS OF THE INVENTION

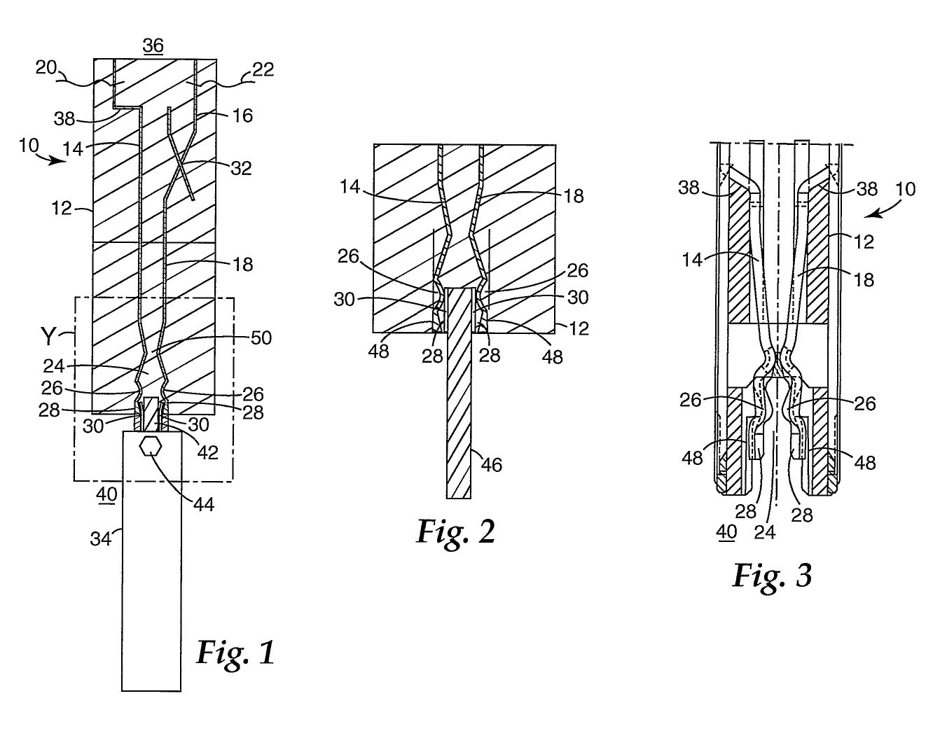

In the schematic sectional side view of FIG. 1, the general shape of the telecommunications module 10 is apparent. The telecommunications module 10, firstly, comprises a housing 12. In the embodiment shown, first 14, second 18 and third 16 contact elements are accommodated in the housing 12. In the sectional side view of FIG. 1, the contact elements are essentially shown as relatively thick lines. However, as will be apparent to those skilled in the art, the contact elements will usually be formed as strip-like elements with a width extending perpendicular to the plane of the drawing of FIG. 1. Moreover, further contact elements 14, 16 and 18 can be present “in front of” and “behind” the plane of the drawing of FIG. 1. Thus, as will be apparent to those skilled in the art, the housing will have a certain extension in a direction perpendicular to the plane of the drawing. The width of the contact elements can be a few millimeters, for example in one exemplary embodiment, so as to allow an IDC to be formed on the contact elements, so that wires 20, 22 can be connected therewith. For this purpose, the first 14 and third 16 contact elements, in the embodiment shown, comprise a contact slit (not visible in FIG. 1) or insulation displacement connector or contact (IDC) slit into which the wires 20, 22 are inserted from the front 36 of the telecommunications module 10. In the embodiment shown, the first contact element 14 comprises an optional step 38 in a front part thereof, which can, for example, be provided in order to reliably position the first contact element 14 within the housing 12. In a rear part thereof, the third contact element 16 is formed in a relatively flat V-type projection, which cooperates with a similar projection formed on the second contact element 18 in a front part thereof. The projections are directed to each other, so that a disconnection point 32 is formed. The V-shaped is an exemplary embodiment. It is understood that the exact configuration of the contact element at disconnection point 32 may be selected as desired. In the situation, which is shown in FIG. 1, an electrical connection between the second 18 and third 16 contact elements is established at disconnection point 32. However, an outside module or plug (not shown), such as a test plug, can be inserted from the front 36 of a telecommunications module 10 so as to disconnect contact elements 18, 16 at the disconnection point 32. The described projections will then be in contact with the outside module or plug in order to allow the desired function to be performed by the module or plug.

A similar disconnection point 50 is provided in the rear part of the telecommunications module 10 between the first 14 and second 18 contact elements. Flat V-type projections, for example, of the first 14 and second 18 contact elements, as described above with regard to disconnection point 32, can be taken from the drawing. It is to be noted that FIG. 1 shows a situation in which an outside module, such as an overvoltage protection module 34 is inserted into the telecommunications module 10 from the rear 40 thereof.

However, when such a module 34 is not inserted, the first 14 and second 18 contact element can be in contact with each other at the disconnection point 50, which is formed by the V-shaped protrusions. Thus, direct electrical connection can be established between wires 20 and 22 via contact elements 14, 18 and 16, when the overvoltage protection module 34 is not present.

However, in the situation shown in FIG. 1, both the first 14 and the second 18 contact elements are connected with outside contacts 30 of the outside module 34. For this purpose, the outside module 34 is partially inserted into a receiving space 24, which is defined between the first 14 and second 18 contact elements. In the embodiment illustrated in FIG. 1, at their positions bordering the receiving space, the first 14 and second 18 contact elements are formed as mirror images of each other. In particular, in the embodiment shown, at a position inside the telecommunications module 10, a bulge is provided, which constitutes a flexible zone 26 of each contact element 14, 18. The bulge constituting the flexible zone 26 could also be formed outside the module or partially inside and partially outside. The bulge extends towards the receiving space and is deformable in the direction away from the receiving space. The effects thereof will be described with reference to FIG. 2.

This is because the flexible zone 26 can be called inactive in FIG. 1. In the situation of FIG. 1, the less flexible zone 28 is used to establish electrical connection with the contacts 30 of the outside module 34. In the embodiment shown, the less flexible zones 28 are relatively straight, as can be taken from the sectional view. When the outside module 34 in the embodiment shown is initially inserted, the contacts 30 are oriented parallel to the center projection 42 of the outside module 34 and adjacent thereto. The center projection 42 can, for example, be made of plastic or any other suitable material. When the contacts 30 are in the described position adjacent the center projection 42, the insertion of the outside module 34 has the effect to spread the contact elements 14, 18 of the telecommunications module 10 apart to some extent. However, in order to establish reliable electrical contact, the outside module 34 has, in the embodiment shown, a manipulator 44, which is connected with the contacts 30 so as to allow these to be spread apart (as shown in FIG. 1), when the manipulator 44 is turned. This also spreads the contact elements 14, 18 further apart and leads to a reliable electrical connection for the following reason.

As shown in FIG. 2, the less flexible zones 28 are each supported by a portion 48 of the housing 12, which prevents further deformation and/or movement of the less flexible zones 28. With regard to FIG. 2, it is to be emphasized that a different type of outside module 34 is shown. In particular, the outside module, which is inserted in the situation shown in FIG. 2, comprises a printed circuit board 46, which in the illustrated embodiment has relatively rigid contacts 30, for example, formed of contact pads. These contact pads are in contact with the flexible zone 26 of both the first 14 and second 18 contact elements. As mentioned, the printed circuit board 46 including the contacts 30 is substantially non-deformable, so that the contact elements 14, 18 are, to some extent, moved apart and/or deformed in the area of the flexible contact zones 26, so that a biasing force is generated which ensures a reliable electrical connection.

A reliable electrical connection can also be realized when the outside module 34 of FIG. 1, having moveable and/or flexible contacts 30, is inserted. To this end, the less flexible zone 28 of both the first 14 and second 18 contact elements is supported by a portion 48 of the housing, which is visible as a substantially triangular structure in FIG. 2. These rigid portions 48 prevent further deformation and/or movement of the less flexible zones 28, so that an appropriate counterforce to the force acting from the moveable contacts 30 is provided. Thus, also in this situation, a reliable electrical connection can be established.

FIG. 3 shows a sectional side view of a part of a second embodiment of the telecommunications module. In particular, only the rear part of the first 14 and second 18 contact elements is shown. In this embodiment both contact elements 14, 18 comprise a step 38, through which they are supported and positioned by suitable structures of the housing 12 of the telecommunications module 10. In a rear part thereof, the contact elements 14, 18 are formed generally similar to the contact elements schematically shown in FIGS. 1 and 2. In particular, at the very rear end, straight portions are formed, which constitute the less flexible zone 28. In the situation shown in FIG. 3, i.e. without any outside module inserted, the less flexible zones extend somewhat towards each other, i.e. converge in a direction towards the rear 40 of the module. In other words, the distance between them increases to some extent towards the inside of the module. However, when an outside module, such as overvoltage connection module 34 shown in FIG. 1 is inserted and its contacts 30 are spread apart, the less flexible zones 28 will be substantially parallel to each other. This can, for example, be taken from the fact that those portions 48 of the housing 12 which support the less flexible zones 28, are substantially parallel in FIG. 3. In an area further inside the telecommunications module 10, both contact elements 14, 18 are formed in a bulge 26 constituting the flexible zone of each contact element 14, 18 in a similar manner as shown and described above for the first embodiment.

The present invention has now been described with reference to several embodiments thereof. The foregoing detailed description and embodiments have been given for clarity of understanding only. No unnecessary limitations are to be understood therefrom. For example, all references to front and rear are exemplary only and do not limit the claimed invention. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A telecommunications module having a housing and at least one contact comprising at least one contact element located at least partially adjacent a receiving space for receiving at least one outside contact the contact having, in a portion bordering the receiving space, both a flexible zone and a zone which is less flexible than the flexible zone and/or supported to exhibit a restrained deformability by force acting from the side of the receiving space.

2. The telecommunications module according to claim 1, further comprising a second contact element at least a portion of which borders the receiving space.

3. The telecommunications module according to claim 1, wherein the less flexible zone is supported so as to be substantially non-deformable.

4. The telecommunications module according to claim 1, wherein the receiving space is accessible from an opening and at least partically widens in a direction towards the inside of the housing.

5. The telecommunications module according to claim 1, further comprising a front where at least one contact element is exposed to allow the connection of wires and a rear where the receiving space is accessible.

6. The telecommunications module according to claim 1, further comprising a third contact element which is connectable with and disconnectable from the first or second contact element at a disconnection point.

7. An assembly of the telecommunications module according to claim 1, and at least one outside module having at least one of the outside contacts.

8. The assembly according to claim 7 wherein the outside module comprises at least one printed circuit board on which the outside contact is formed.

9. A method of using the telecommunications module according to claim 1, wherein at least one outside module having at least one flexible contact is at least partially inserted into the telecommunications module and removed from the telecommunications module at a later point in time, and wherein at least one outside module having at least one substantially inflexible contact is then at least partially inserted into the telecommunications module.

10. A method of using the telecommunications module according to claim 1, wherein at least one outside module having at least one substantially inflexible contact is at least partially inserted into the telecommunications module and removed from the telecommunications module at a later point in time, and wherein at least one outside module having at least one flexible contact is then at least partially inserted into the telecommunications module.
